(19) United States
(12) Patent Application Publication
(10) Pub. No.: US 2025/0196385 A1
(43) Pub. Date: Jun. 19, 2025

(54) MEASURING METHOD, MEASURING APPARATUS, AND WORKPIECE PROCESSING METHOD

(71) Applicant: DISCO CORPORATION, Tokyo (JP)

(72) Inventor: Kensuke FURUTA, Tokyo (JP)

(21) Appl. No.: 18/953,671

(22) Filed: Nov. 20, 2024

(30) Foreign Application Priority Data
Dec. 18, 2023 (JP) 2023-213368

(51) Int. Cl. B26D 5/40; B26D 1/12

(52) U.S. Cl. CPC B26D 5/40; B26D 1/12

(57) ABSTRACT

A measuring method for measuring a height of an upper surface of a stepped portion provided to an outer circumference on a top surface side of a measurement target object includes a holding step of holding an undersurface side of the measurement target object by a holding table such that the stepped portion is exposed upward, and a measuring step of measuring the height of the upper surface of the stepped portion by a measuring unit, a width of a measurement region on the upper surface of the stepped portion to be measured by the measuring unit in one time of measurement being smaller than a width of the stepped portion, and in the measuring step, the height of the upper surface of the stepped portion is measured at a plurality of measurement positions having different distances from the outer circumference of the measurement target object.

### BACKGROUND OF THE INVENTION

### Field of the Invention

The present invention relates to a measuring method and a measuring apparatus that measure the height of an upper surface of a stepped portion in a measurement target object that is provided with the stepped portion at an outer circumference on a top surface side and a processing method that provides a stepped portion to the outer circumference of a workpiece by processing the workpiece and measures the height of an upper surface of the stepped portion.

### Description of the Related Art

Device chip manufacturing processes use a disk-shaped wafer having such a device as an integrated circuit (IC) or a large scale integration (LSI) circuit formed in each of a plurality of regions thereof divided by a plurality of planned dividing lines (streets) that intersects one another. A plurality of device chips respectively including the devices is obtained by dividing the wafer along the planned dividing lines. The device chips are mounted in various electronic apparatuses such as mobile telephones and personal computers. In recent years, there has been a noticeable tendency for the miniaturization of the electronic apparatuses, and there has also been an increasing demand for the thinning of the device chips. Accordingly, the wafer is thinned to a predetermined finished thickness by being ground an undersurface side thereof by a grinding apparatus before being divided, and the thinned wafer is divided. In this case, thin device chips are ultimately obtained.

A chamfered portion from which an angular portion is removed is formed at an outer circumferential portion of the wafer. Further, when a part of the chamfered portion is removed at a time of the thinning of the wafer, a pointed shape in the form of a knife edge appears, and thus, the wafer is easily damaged. Accordingly, edge trimming processing which partially removes the chamfered portion by cutting the outer circumferential portion of the wafer to a depth exceeding a finished thickness from the top surface side by a cutting apparatus before grinding the wafer is performed (see Japanese Patent Laid-Open No. 2000-173961 and Japanese Patent Laid-Open No. 2010-245167). When the edge trimming processing is performed, a stepped portion is formed on the top surface side of the wafer along an outer circumference thereof.

### SUMMARY OF THE INVENTION

A cutting edge is constituted by abrasive grains and a binding material that disperses and fixes the abrasive grains. The abrasive grains are exposed from the binding material at an outer circumference of the cutting edge. When a plurality of wafers is cut one after another, the binding material of the cutting edge is worn, some of the abrasive grains greatly protrude to the outer circumference, and the wafer is ground deeply at a part with which the protruding abrasive grains are in contact. Then, height variations reflecting the protrusion conditions of the abrasive grains occur in an upper surface of the stepped portion formed by edge trimming. That is, the surface of the stepped portion becomes low in quality. In addition, the wear of the cutting edge of the cutting blade tends to progress particularly at an angular portion of the cutting edge, and the angular portion of the cutting edge is gradually rounded while the edge trimming is repeated. When the edge trimming is further performed by the cutting edge whose angular portion is rounded, the stepped portion has a curved surface, and the wafer is not removed to a sufficient depth particularly at an inner circumferential portion of the stepped portion.

Thus, various problems occur at the cutting edge of the cutting blade when the cutting apparatus repeatedly performs the edge trimming processing on a plurality of wafers. Accordingly, there is a demand for measuring the heights of different positions of the stepped portion formed in the wafer and checking the state of the cutting edge from a result of the measurement after performing the edge trimming processing.

It is accordingly an object of the present invention to provide a measuring method and a measuring apparatus that measure the height of an upper surface of a stepped portion formed in a measurement target object such as a wafer by edge trimming processing. Alternatively, it is an object of the present invention to provide a processing method that provides a stepped portion to an outer circumference of a workpiece by processing the workpiece and measures the height of an upper surface of the stepped portion.

In accordance with an aspect of the present invention, there is provided a measuring method for measuring a height of an upper surface of a stepped portion provided to an outer circumference on a top surface side of a measurement target object, the measuring method including a holding step of holding an undersurface side of the measurement target object by a holding table such that the stepped portion is exposed upward, and a measuring step of measuring the height of the upper surface of the stepped portion by a measuring unit configured to measure the height of the upper surface of the stepped portion of the measurement target object held by the holding table, in which a width of a measurement region on the upper surface of the stepped portion to be measured by the measuring unit in one time of measurement is smaller than a width of the stepped portion, and, in the measuring step measuring the height of the upper surface of the stepped portion is measured at a plurality of measurement positions having different distances from the outer circumference of the measurement target object.

Preferably, in the measuring step, the holding table and the measuring unit are moved relative to each other such that the holding table and the measuring unit are moved along the outer circumference of the measurement target object while oscillating the holding table and the measuring unit relative to each other in a direction from a center of the measurement target object to the outer circumference and in a direction from the outer circumference to the center, and the height of the upper surface of the stepped portion is measured at the plurality of measurement positions.

Alternatively, preferably, the measuring step includes a first circumferential direction measuring step of measuring the height of the upper surface of the stepped portion at the plurality of measurement positions while moving the holding table and the measuring unit relative to each other such that the holding table and the measuring unit are moved along the outer circumference of the measurement target object, a moving step of, after the first circumferential direction measuring step, moving the holding table and the measuring unit relative to each other in a direction from a center of the measurement target object to the outer circumference or in a direction from the outer circumference to the center, and a second circumferential direction measuring step of, after the moving step, measuring the height of the upper surface of the stepped portion at the plurality of measurement positions while moving the holding table and the measuring unit relative to each other such that the holding table and the measuring unit are moved along the outer circumference of the measurement target object.

Moreover, preferably, the measurement target object is an integral object obtained by laminating one surface of a disk-shaped wafer and a supporting surface of a supporting substrate to each other by a laminating member, and in the measuring step, the height of the upper surface of the stepped portion formed on another surface side of the wafer, which is the top surface side of the measurement target object, is measured.

More preferably, the stepped portion is formed by making a rotating cutting blade cut the outer circumference of the measurement target object.

In accordance with another aspect of the present invention, there is provided a processing method for processing a workpiece, the processing method including a holding step of holding an undersurface side of the workpiece by a holding table such that a top surface side of the workpiece is exposed upward, a first cutting step of forming a stepped portion in the workpiece by cutting an outer circumference of the workpiece held by the holding table, with use of a first cutting blade fitted to a distal end of a rotatable spindle, and a measuring step of, after the first cutting step, measuring a height of an upper surface of the stepped portion by a measuring unit configured to measure the height of the upper surface of the stepped portion of the workpiece, in which a width of a measurement region on the upper surface of the stepped portion to be measured by the measuring unit in one time of measurement is smaller than a width of the stepped portion, and, in the measuring step, information regarding the height of the upper surface of the stepped portion is obtained by measuring the height of the upper surface of the stepped portion at a plurality of measurement positions having different distances from the outer circumference of the workpiece.

Preferably, the processing method further includes a second cutting step of, after the measuring step, further cutting the stepped portion of the workpiece by the first cutting blade or a second cutting blade including abrasive grains having a diameter smaller than a diameter of abrasive grains included in the first cutting blade, in which in the second cutting step, an amount of cutting of the first cutting blade or the second cutting blade is determined based on the information obtained in the measuring step.

In accordance with a further aspect of the present invention, there is provided a measuring apparatus for measuring a height of an upper surface of a stepped portion provided to an outer circumference on a top surface side of a measurement target object, the measuring apparatus including a holding table that has a holding surface and is configured to hold an undersurface side of the measurement target object placed on the holding surface such that the stepped portion is exposed upward, a measuring unit configured to measure the height of the upper surface of the stepped portion of the measurement target object held by the holding table, and a moving unit configured to move the holding table and the measuring unit relative to each other, in which a width of a measurement region on the upper surface of the stepped portion to be measured by the measuring unit in one time of measurement is smaller than a width of the stepped portion, and the measuring apparatus is capable of measuring the height of the upper surface of the stepped portion by the measuring unit at a plurality of measurement positions having different distances from the outer circumference of the measurement target object while controlling the moving unit to move the holding table and the measuring unit relative to each other.

Preferably, the moving unit is controlled to oscillate the holding table and the measuring unit relative to each other in a direction from a center of the measurement target object to the outer circumference and in a direction from the outer circumference to the center and to move the holding table and the measuring unit relative to each other such that the holding table and the measuring unit move along the outer circumference of the measurement target object, and the height of the upper surface of the stepped portion is measured at the plurality of measurement positions.

Alternatively, preferably, the height of the upper surface of the stepped portion is measured by the measuring unit while the moving unit is controlled to move the holding table and the measuring unit such that the holding table and the measuring unit move along the outer circumference of the measurement target object, the moving unit is controlled to next move the holding table and the measuring unit relative to each other in a direction from a center of the measurement target object to the outer circumference or in a direction from the outer circumference to the center, and then, the height of the upper surface of the stepped portion is measured while the moving unit is controlled to move the holding table and the measuring unit such that the holding table and the measuring unit move along the outer circumference of the measurement target object.

Moreover, preferably, the measurement target object is an integral object obtained by laminating one surface of a disk-shaped wafer and a supporting surface of a supporting substrate to each other by a laminating member, and the height of the upper surface of the stepped portion formed on another surface side of the wafer, the other surface side corresponding to the top surface side of the measurement target object, is measured by the measuring unit.

More preferably, the stepped portion is formed by making a rotating cutting blade cut the outer circumference of the measurement target object.

In the measuring method, the measuring apparatus, and the workpiece processing method according to one aspect of the present invention, the width of the measurement region on the stepped portion to be measured by the measuring unit in one time of measurement is smaller than the width of the stepped portion. Further, the measuring unit measures the height of the upper surface of the stepped portion at a plurality of measurement positions having different distances from the outer circumference of the measurement target object. It is therefore possible to measure a height distribution in the width direction of the stepped portion.

Hence, according to one aspect of the present invention, a measuring method and a measuring apparatus which measure the height of an upper surface of a stepped portion formed in a measurement target object such as a wafer by edge trimming processing are provided. Alternatively, a processing method which provides a stepped portion to an outer circumference of a workpiece by processing the workpiece and measures the height of an upper surface of the stepped portion is provided.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating a measurement target object;

FIG. 2 is a perspective view schematically illustrating a cutting apparatus;

FIG. 3 is a sectional view schematically illustrating the measurement target object held by a holding table;

FIG. 4 is a sectional view schematically illustrating the measurement target object whose outer circumference is being cut by a first cutting blade;

FIG. 5 is a sectional view schematically illustrating a state in which the height of an upper surface of a stepped portion is being measured;

FIG. 6 is a plan view schematically illustrating an example of the trajectory of a measurement region on the stepped portion;

FIG. 7 is a plan view schematically illustrating another example of the trajectory of the measurement region on the stepped portion;

FIG. 8 is a sectional view schematically illustrating the measurement target object whose stepped portion is being cut by a second cutting blade;

FIG. 9 is a sectional view schematically illustrating an integral object formed by laminating a wafer and a supporting substrate;

FIG. 10 is a sectional view schematically illustrating the integral object having an outer circumference that is being cut by the first cutting blade;

FIG. 11 is a sectional view schematically illustrating a state in which the height of the upper surface of the stepped portion is being measured;

FIG. 12A is a flowchart illustrating a flow of a measuring method according to an embodiment;

FIG. 12B is a flowchart illustrating a flow of a measuring step according to an example; and

FIG. 12C is a flowchart illustrating a flow of a processing method according to the embodiment.

### DETAILED DESCRIPTION OF THE PREFERRED EMBODIMENT

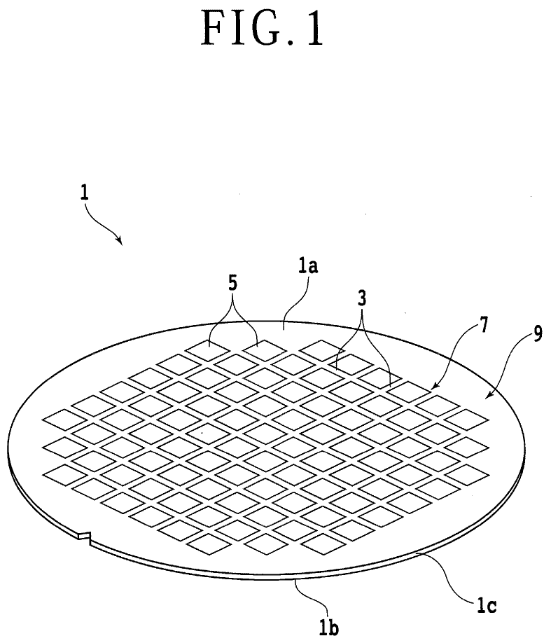

An embodiment of the present invention will hereinafter be described in detail with reference to the accompanying drawings. Description will first be made of a measurement target object to be measured by a measuring method and a measuring apparatus according to the present embodiment. The measurement target object is also a workpiece to be processed by a cutting apparatus. FIG. 1 is a perspective view schematically illustrating an example of a measurement target object 1.

The measurement target object 1 is, for example, a disk-shaped wafer formed of a semiconductor material such as silicon. The measurement target object 1 has a top surface 1a and an undersurface 1b that are substantially parallel with each other. A plurality of planned dividing lines 3 arranged in a grid manner to intersect each other is set on the top surface 1a of the measurement target object 1. A device 5 such as an IC or an LSI circuit is formed in each of regions demarcated by the planned dividing lines 3 on the top surface 1a of the measurement target object 1. A region in which the devices 5 are formed on the top surface 1a of the measurement target object 1 is referred to as a device region 7. An outside region surrounding the device region 7 is referred to as a peripheral surplus region 9. It is to be noted that there are no limitations on the material, structure, size, and the like of the measurement target object 1. For example, the measurement target object 1 may be a substrate formed of a semiconductor (gallium arsenide (GaAs), indium phosphide (InP), gallium nitride (GaN), silicon carbide (SiC), or the like) other than silicon, sapphire, glass (quartz glass, borosilicate glass, or the like), or the like. The measurement target object 1 does not have to be of a disk shape, and may be of a rectangular plate shape. In addition, there are no limitations on the kind, quantity, shape, structure, size, arrangement, and the like of the devices 5 either. No devices 5 may be formed on the measurement target object 1.

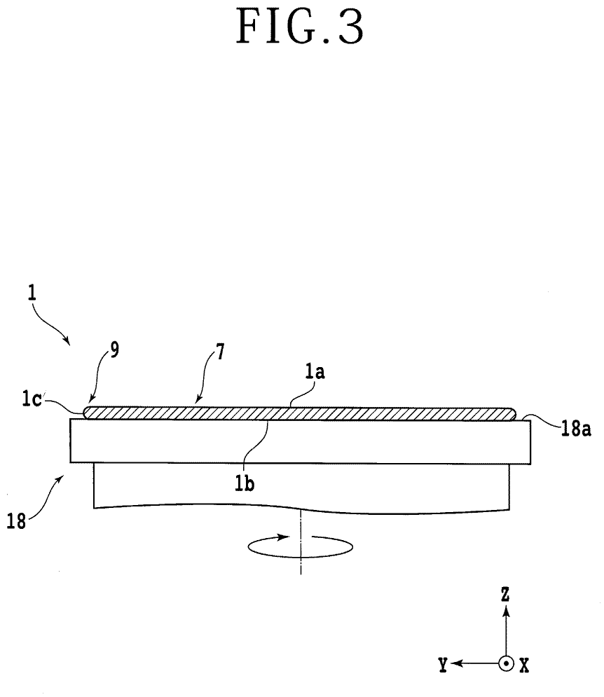

When an outer circumference 1c of the measurement target object 1 has an angular portion, chipping or cracking tends to occur at a time when the measurement target object 1 receives an impact at the angular portion. A device (Devices) 5 is (are) damaged when this chipping or cracking progresses from the peripheral surplus region 9 to the device region 7. Accordingly, the outer circumference 1c of the measurement target object 1 is subjected to chamfering processing in advance to remove the angular portion, so that a rounded chamfered portion is formed. FIG. 3 includes a sectional view illustrating the chamfered portion formed at the outer circumference 1c of the measurement target object 1.

When the measurement target object 1 is thinned by being ground from the undersurface 1b side and is divided along the planned dividing lines 3, a plurality of thin chips (device chips) respectively including the devices 5 is manufactured. Used for the division of the measurement target object 1 is, for example, a cutting apparatus provided with an annular cutting blade or a laser processing apparatus provided with a laser processing unit that irradiates the measurement target object 1 with a laser beam. The device chips manufactured by these processing apparatuses are mounted in various electronic apparatuses such as mobile telephones and personal computers. However, when the measurement target object 1 having the chamfered portion formed at the outer circumference 1c is ground and thinned, a pointed shape in the form of a knife edge appears at the outer circumference 1c, and thus, the measurement target object 1 is easily damaged. Accordingly, performed is edge trimming which partially removes the chamfered portion by cutting the outer circumference 1c of the measurement target object 1 by the cutting apparatus from the top surface 1a side to a depth exceeding a finished thickness before the measurement target object 1 is ground from the undersurface 1b side. When the edge trimming is performed, a stepped portion is formed on the top surface 1a side of the measurement target object 1 along the outer circumference 1c.

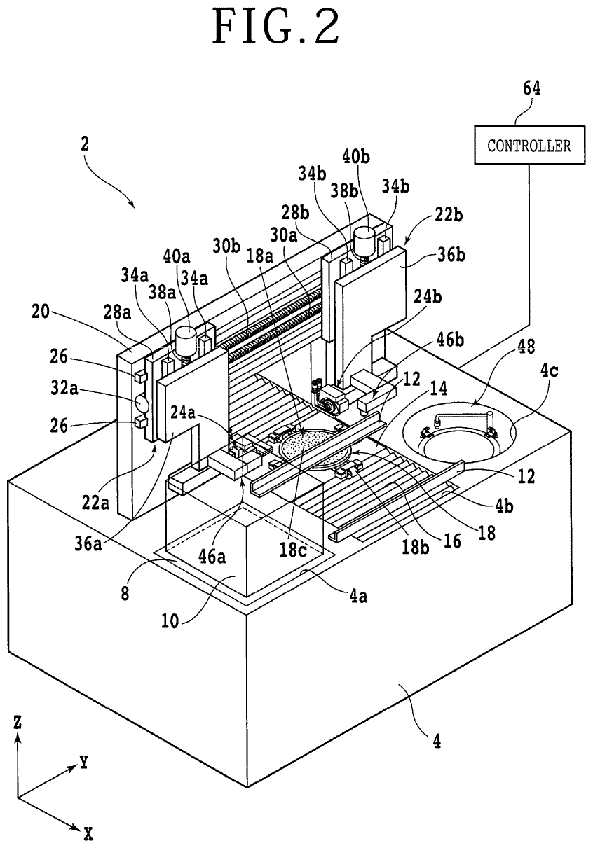

Description will next be made of a cutting apparatus that performs the edge trimming by cutting the measurement target object 1. FIG. 2 is a perspective view schematically illustrating a cutting apparatus 2. As will be described later, the cutting apparatus 2 functions also as a measuring apparatus that measures the height of the upper surface of the stepped portion provided to the outer circumference 1c on the top surface 1a side of the measurement target object 1. The measurement target object 1 to be edge-trimmed by the cutting apparatus (measuring apparatus) 2 is, for example, loaded into the cutting apparatus 2 in a state in which the measurement target object 1 is integrated with an annular frame (not illustrated) having an opening of a larger diameter than the diameter of the measurement target object 1 and a tape affixed to the annular frame in such a manner as to close the opening of the annular frame. When a frame unit is formed by integrating the measurement target object 1, the tape, and the annular frame, the measurement target object 1 can be handled via the annular frame, and therefore, the handling of the measurement target object 1 is facilitated. Incidentally, the tape is affixed to the undersurface 1b side of the measurement target object 1, and the top surface 1a side of the measurement target object 1 is exposed upward.

The cutting apparatus 2 includes a base 4 that supports various constituent elements. An opening 4a is formed in an angular portion of a front of the base 4. A cassette support base 8 that is raised and lowered by a raising and lowering mechanism (not illustrated) is provided in the opening 4a. A cassette 10 housing a plurality of measurement target objects 1 that each constitute a part of a frame unit is mounted on an upper surface of the cassette support base 8. Incidentally, for the convenience of description, FIG. 1 illustrates only a contour of the cassette 10.

A rectangular opening 4b is formed on a side of the cassette support base 8 such that a longitudinal direction of the rectangular opening 4b is along an X-axis direction (a front-rear direction and a processing feed direction). Arranged in the opening 4b is a ball-screw-type X-axis moving mechanism (not illustrated) as well as a table cover 14 and a dustproof and dripproof cover 16 that cover an upper portion of the X-axis moving mechanism. The X-axis moving mechanism includes an X-axis moving table (not illustrated) covered by the table cover 14, and moves the X-axis moving table in the X-axis direction. A holding table 18 is disposed on an upper surface of the X-axis moving table in such a manner as to be exposed from the table cover 14. The holding table 18 has a function of holding under suction the measurement target object 1 placed on a holding surface 18a exposed upward. The holding table 18 is coupled to a rotational driving source (not illustrated) such as a motor, and is rotated about a rotational axis substantially parallel with a Z-axis direction (vertical direction).

The holding table 18 includes a porous member 18c having a diameter similar to that of the measurement target object 1 and a frame body that covers the porous member 18c. A suction passage (not illustrated) is formed in the holding table 18, the suction passage having one end connected to a suction source (not illustrated) such as an ejector provided outside the holding table 18. Another end of the suction passage reaches the porous member 18c. An upper surface of the porous member 18c is exposed at the holding surface 18a of the holding table 18. The upper surface of the porous member 18c has a diameter equal to that of the measurement target object 1, and is formed substantially parallel with the X-axis direction and a Y-axis direction. Further, a plurality of clamps 18b for fixing the annular frame supporting the measurement target object 1 is provided to the periphery of the holding table 18. When the measurement target object 1 is to be held by the holding table 18, first, the frame unit including the measurement target object 1 is placed on the holding surface 18a of the holding table 18. Then, the suction source and the porous member 18c are connected to each other via the suction passage, and a negative pressure is made to act on the measurement target object 1 via the tape affixed to the undersurface 1b of the measurement target object 1.

The cutting apparatus 2 includes, in a region adjacent to the opening 4b, a transporting unit (not illustrated) that transports the measurement target object 1 to the holding table 18 or the like. A temporary placement mechanism for temporarily placing the measurement target object 1 is provided at a position in proximity to a side of the cassette support base 8. The temporary placement mechanism includes, for example, a pair of guide rails 12 that are brought into proximity to or separated from each other while maintaining a state of being parallel with the Y-axis direction (indexing feed direction). The pair of guide rails 12 sandwich, along the X-axis direction, the measurement target object 1 drawn out from the cassette 10 by the transporting unit, and thereby sets the measurement target object 1 at a predetermined position. The measurement target object 1 set at the predetermined position is lifted and transported to the holding table 18 by the transporting unit. At this time, the pair of guide rail 12 are separated from each other, and the measurement target object 1 is passed between the pair of guide rails 12.

A first cutting unit 24a and a second cutting unit 24b that cut the measurement target object 1 by an annular cutting blade are provided above the holding table 18. A gate-type supporting structure 20 for supporting the first cutting unit 24a and the second cutting unit 24b is disposed on an upper surface of the base 4 in such a manner as to straddle the opening 4b.

An upper portion of a front surface of the supporting structure 20 is provided with a moving unit 22a that moves the first cutting unit 24a in the Y-axis direction and the Z-axis direction as well as a moving unit 22b that moves the second cutting unit 24b in the Y-axis direction and the Z-axis direction. The moving unit 22a includes a Y-axis moving plate 28a. The moving unit 22b includes a Y-axis moving plate 28b. The two Y-axis moving plates 28a and 28b are slidably fitted to a pair of Y-axis guide rails 26 arranged on the front surface of the supporting structure 20 along the Y-axis direction. The back surface side (rear surface side) of the Y-axis moving plate 28a is provided with a nut portion (not illustrated). A Y-axis ball screw 30a substantially parallel with the Y-axis guide rails 26 is screwed into the nut portion. In addition, the back surface side (rear surface side) of the Y-axis moving plate 28b is provided with a nut portion (not illustrated). A Y-axis ball screw 30b substantially parallel with the Y-axis guide rails 26 is screwed into the nut portion.

A Y-axis pulse motor 32a is coupled to one end of the Y-axis ball screw 30a. When the Y-axis pulse motor 32a rotates the Y-axis ball screw 30a, the Y-axis moving plate 28a is moved in the Y-axis direction along the Y-axis guide rails 26. In addition, a Y-axis pulse motor (not illustrated) is coupled to one end of the Y-axis ball screw 30b. When the Y-axis pulse motor rotates the Y-axis ball screw 30b, the Y-axis moving plate 28b is moved in the Y-axis direction along the Y-axis guide rails 26.

The front surface (front) side of the Y-axis moving plate 28a is provided with a pair of Z-axis guide rails 34a along the Z-axis direction. The front surface (front) side of the Y-axis moving plate 28b is provided with a pair of Z-axis guide rails 34b along the Z-axis direction. In addition, a Z-axis moving plate 36a is slidably attached to the pair of Z-axis guide rails 34a, and a Z-axis moving plate 36b is slidably attached to the pair of Z-axis guide rails 34b. The back surface side (rear surface side) of the Z-axis moving plate 36a is provided with a nut portion (not illustrated). A Z-axis ball screw 38a provided in such a manner as to be along a direction substantially parallel with the Z-axis guide rails 34a is screwed into the nut portion. A Z-axis pulse motor 40a is coupled to one end of the Z-axis ball screw 38a. When the Z-axis pulse motor 40a rotates the Z-axis ball screw 38a, the Z-axis moving plate 36a is moved in the Z-axis direction along the Z-axis guide rails 34a.

The back surface side (rear surface side) of the Z-axis moving plate 36b is provided with a nut portion (not illustrated). A Z-axis ball screw 38b provided in such a manner as to be along a direction substantially parallel with the Z-axis guide rails 34b is screwed into the nut portion. A Z-axis pulse motor 40b is coupled to one end of the Z-axis ball screw 38b. When the Z-axis pulse motor 40b rotates the Z-axis ball screw 38b, the Z-axis moving plate 36b is moved in the Z-axis direction along the Z-axis guide rails 34b.

The first cutting unit 24a is provided to a lower portion of the Z-axis moving plate 36a. A camera unit 46a for photographing the measurement target object 1 held under suction by the holding table 18 is provided at a position adjacent to the first cutting unit 24a. In addition, the second cutting unit 24b is provided to a lower portion of the Z-axis moving plate 36b. A camera unit 46b for photographing the measurement target object 1 held under suction by the holding table 18 is provided at a position adjacent to the second cutting unit 24b. The moving unit 22a controls the positions in the Y-axis direction and the Z-axis direction of the first cutting unit 24a and the camera unit 46a. The moving unit 22b controls the positions in the Y-axis direction and the Z-axis direction of the second cutting unit 24b and the camera unit 46b. The position of the first cutting unit 24a and the position of the second cutting unit 24b are controlled independently of each other.

An opening 4c is formed at a position on an opposite side of the opening 4b with respect to the opening 4a. A cleaning unit 48 for cleaning the measurement target object 1 is disposed in the opening 4c. The measurement target object 1 after being cut on the holding table 18 is cleaned by the cleaning unit 48. The measurement target object 1 after being cleaned by the cleaning unit 48 is housed in the cassette 10 again.

The cutting apparatus 2 further includes a controller (control unit) 64 that controls various constituent elements. The controller 64 is, for example, constituted by a computer including a processing device and a storage device. The controller 64 controls the operations and the like of respective elements of the cutting apparatus 2 such that the measurement target object 1 is subjected to edge trimming processing appropriately. The controller 64 controls, for example, each of the cutting units 24a and 24b, the holding table 18, the transporting unit, the camera units 46a and 46b, the cleaning unit 48, each moving unit, and the like. The processing device is typically a central processing unit (CPU). The processing device performs various kinds of processing necessary to control the above-described elements. The storage device includes, for example, a main storage device such as a dynamic random access memory (DRAM) and an auxiliary storage device such as a hard disk drive and a flash memory. Functions of the controller 64 are, for example, implemented by the processing device operating according to a program (software) stored in the storage device. However, the controller 64 may be implemented by only hardware.

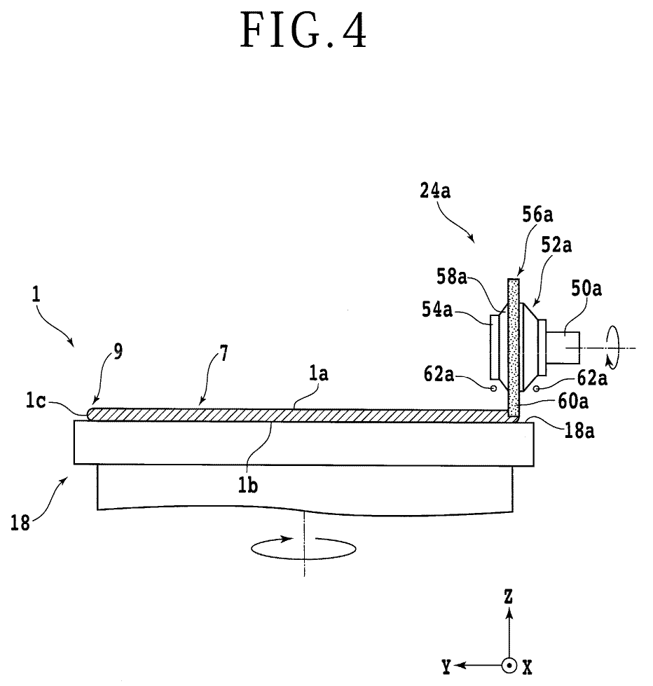

Each of the cutting units 24a and 24b will be described in more detail in the following. FIG. 4 is a sectional view schematically illustrating the measurement target object 1 being cut by the first cutting unit 24a. The first cutting unit 24a is used for edge trimming that removes a part of the chamfered portion by cutting the measurement target object 1 along the outer circumference 1c. Incidentally, FIG. 4 and the like omit the clamps 18b of the holding table 18, the camera unit 46a, the annular frame, the tape, and the like. The first cutting unit 24a includes a spindle 50a along the Y-axis direction and a rotational driving source (not illustrated) such as a motor connected to the proximal end side of the spindle 50a. An annular first cutting blade 56a is fixed to a distal end of the spindle 50a via a flange mechanism 52a.

The first cutting blade 56a is, for example, a cutting blade referred to as a hub type that has an annular base 58a which is formed of such a material as aluminum and which has an insertion hole formed in a center thereof and a cutting edge 60a fixed to an outer circumference of the base 58a. However, the first cutting blade 56a is not limited to the hub type. The cutting edge (grindstone portion) 60a including an infinite number of abrasive grains and a binding material (bond) that disperses and fixes the abrasive grains is fixed to the outer circumference of the base 58a. For example, the abrasive grains are formed of such a material as diamond or cubic boron nitride (cBN), and the binding material is a nickel plating layer or the like. The blade thickness of the first cutting blade 56a used for the edge trimming processing is preferably determined according to the width of the stepped portion formed in the measurement target object 1, and is, for example, preferably 2 mm or more. However, the blade thickness of the first cutting blade 56a is not limited to this.

A boss portion (not illustrated) of the flange mechanism 52a which boss portion projects in the Y-axis direction is inserted into the insertion hole of the base 58a, the first cutting blade 56a is brought into contact with a flange surface of the flange mechanism 52a, and a fixing nut 54a is fastened to a distal end of the boss portion. Then, the first cutting blade 56a can be fixed to the distal end of the spindle 50a. In addition, the first cutting unit 24a includes a pair of cutting liquid supply nozzles 62a arranged in such a manner as to sandwich a lower portion of the first cutting blade 56a fixed to the distal end of the spindle 50a.

The first cutting blade 56a can be rotated when the spindle 50a is rotated by the rotational driving source being actuated. The measurement target object 1 can be cut when the rotating first cutting blade 56a is made to cut into the measurement target object 1 held under suction on the holding table 18. At this time, cutting liquid such as pure water is jetted from the cutting liquid supply nozzles 62a to the measurement target object 1 and the first cutting blade 56a, so that processing waste and friction heat produced by the cutting are removed by the cutting liquid.

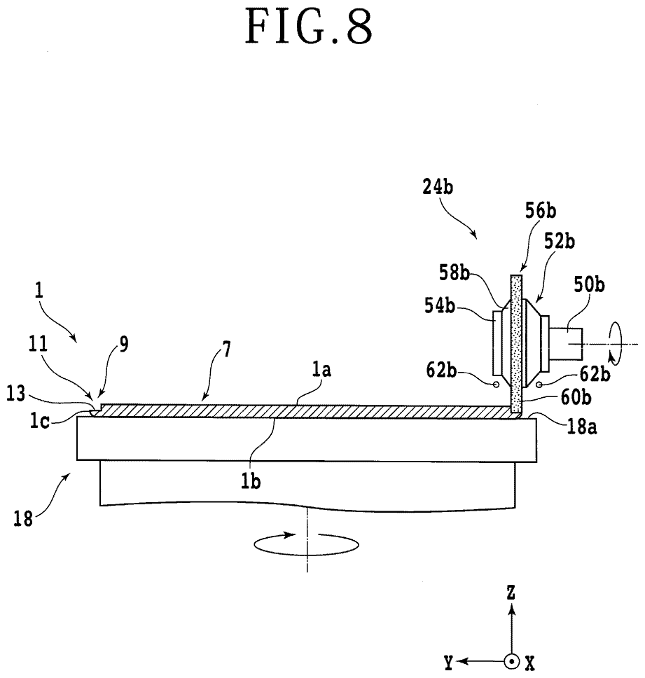

FIG. 8 is a sectional view schematically illustrating the measurement target object 1 being cut by the second cutting unit 24b. Incidentally, FIG. 8 omits the clamps 18b of the holding table 18, the camera unit 46b, the annular frame, the tape, and the like. The second cutting unit 24b is, for example, used to further cut the upper surface of the stepped portion formed at the outer circumference 1c of the measurement target object 1 by the first cutting unit 24a. The second cutting unit 24b is configured in a manner similar to that of the first cutting unit 24a. Description of a part of the second cutting unit 24b will therefore be omitted. The second cutting unit 24b includes a spindle 50b along the Y-axis direction and a rotational driving source (not illustrated) such as a motor connected to the proximal end side of the spindle 50b. An annular second cutting blade 56b is fixed to a distal end of the spindle 50b via a flange mechanism 52b. The second cutting unit 24b includes a pair of cutting liquid supply nozzles 62b arranged in such a manner as to sandwich a lower portion of the second cutting blade 56b fixed to the distal end of the spindle 50b.

The second cutting blade 56b is, for example, a cutting blade referred to as the hub type that has an annular base 58b which is formed of such a material as aluminum and which has an insertion hole formed in a center thereof and a cutting edge 60b fixed to an outer circumference of the base 58b. However, the second cutting blade 56b is not limited to the hub type. The cutting edge (grindstone portion) 60b including an infinite number of abrasive grains and a binding material (bond) that disperses and fixes the abrasive grains is fixed to the outer circumference of the base 58b. The blade thickness of the second cutting blade 56b used for the edge trimming processing is also preferably determined according to the width of the stepped portion formed in the measurement target object 1, and is, for example, preferably 2 mm or more. However, the blade thickness of the second cutting blade 56b is not limited to this.

Incidentally, the diameters of the abrasive grains included in the cutting edge 60b of the second cutting blade 56b are preferably smaller than the diameters of the abrasive grains included in the cutting edge 60a of the first cutting blade 56a. However, this does not mean that all of the diameters of the abrasive grains included in the cutting edge 60b of the second cutting blade 56b are smaller than that of any abrasive grain included in the cutting edge 60a of the first cutting blade 56a. As a method of comparing the diameters of the abrasive grains, a method of comparing average grain diameters, for example, is possible. Further, a magnitude relation between the diameters of the abrasive grains included in the cutting edges 60a and 60b may be estimated from a result obtained at a time of cutting the measurement target object 1 by the cutting edges 60a and 60b.

For example, when the measurement target object 1 is cut by a cutting blade having a cutting edge including abrasive grains of relatively large grain diameters, the measurement target object 1 can be cut at a relatively high speed, whereas an uneven shape having a relatively large height difference tends to occur at the surface of a cutting trace formed on the measurement target object 1. Conversely, when the measurement target object 1 is cut by a cutting blade having a cutting edge including abrasive grains of relatively small grain diameters, it is difficult to cut the measurement target object 1 at a high speed, whereas the height difference of an uneven shape appearing on the surface of a cutting trace formed on the measurement target object 1 is relatively small. In a case of using the first cutting blade 56a and the second cutting blade 56b in the cutting apparatus 2, it is preferable to form the stepped portion quickly by first using the first cutting blade 56a, and enhance the flatness of the upper surface of the stepped portion by next cutting the upper surface of the stepped portion by the second cutting blade 56b.

However, the cutting apparatus 2 may be fitted with two cutting blades having equal performance. That is, the cutting apparatus 2 may be fitted with another first cutting blade 56a in place of the second cutting blade 56b. In addition, the cutting apparatus 2 does not need to be provided with the two cutting units 24a and 24b, and may be provided with one cutting unit.

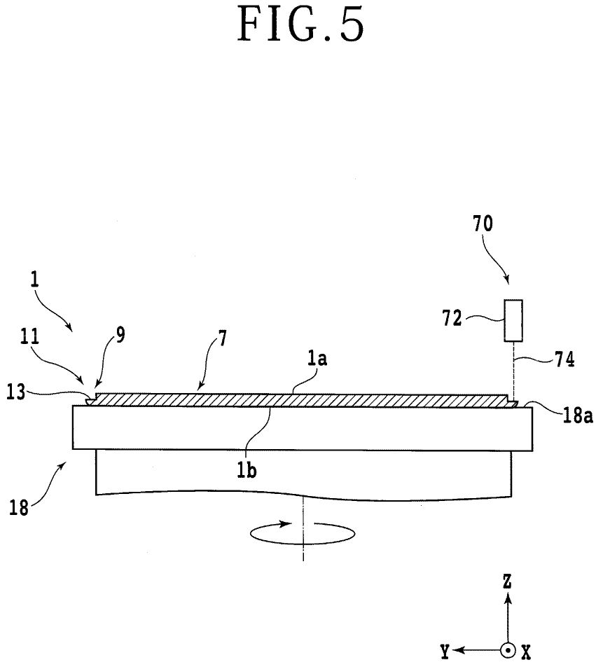

In the cutting apparatus 2, the measurement target object 1 unloaded from the cassette 10 and adjusted in position by the guide rails 12 is mounted onto the holding table 18 by the transporting unit, and the measurement target object 1 is held under suction by the holding table 18. Then, the position of a cutting target region in the measurement target object 1 is checked by the camera units 46a and 46b. Subsequently, the moving units 22a and 22b are actuated while the holding table 18 is moved, and the cutting blades 56a and 56b that are rotating are thereby made to cut the outer circumference 1c of the measurement target object 1. At this time, the cutting liquid is supplied to the measurement target object 1 and the like from the cutting liquid supply nozzles 62a and 62b. FIG. 4 is a sectional view schematically illustrating a state in which the first cutting blade 56a is cutting the measurement target object 1. Next, the holding table 18 is rotated by an amount of rotation equal to or more than one rotation about a rotational axis intersecting the holding surface 18a, and the measurement target object 1 is thus cut along the outer circumference 1c. A stepped portion is thereby formed at the outer circumference 1c of the measurement target object 1. FIG. 5 includes a sectional view schematically illustrating the measurement target object 1 having a stepped portion 11 formed along the outer circumference 1c. Thereafter, the measurement target object 1 is unloaded from the holding table 18, the measurement target object 1 is cleaned by the cleaning unit 48, and the measurement target object 1 is housed into the cassette 10. The processing of the measurement target object 1 by the cutting apparatus 2 is thereby completed.

Here, as described above, the abrasive grains are exposed from the binding materials of the cutting edges 60a and 60b of the cutting blades 56a and 56b, and the states of the cutting edges 60a and 60b change when the cutting edges 60a and 60b cut the measurement target object 1. Further, an upper surface 13 of the stepped portion 11 formed by the edge trimming may have large variations in height along a width direction. That is, the upper surface 13 of the stepped portion 11 may become low in quality. In addition, the wearing of the cutting edges 60a and 60b of the cutting blades 56a and 56b tends to progress particularly at angular portions of the cutting edges 60a and 60b, and the angular portions are gradually rounded while the edge trimming is repeated. When the edge trimming is further performed by the cutting edges 60a and 60b whose angular portions are rounded, the stepped portion 11 has a curved surface on the inside in a radial direction, and thus, the measurement target object 1 is not removed to a sufficient depth particularly at an inner circumferential portion of the stepped portion 11.

Thus, when the cutting apparatus 2 successively performs the edge trimming of a plurality of measurement target objects 1, various problems occur at the cutting edges 60a and 60b of the cutting blades 56a and 56b. Therefore, there is a demand for measuring the heights of different positions of the upper surface 13 of the stepped portion 11 formed in the measurement target object 1 and checking the states of the cutting edges 60a and 60b from a result of the measurement after performing the edge trimming. In particular, there is a demand for measuring in detail a distribution of heights in the width direction of the stepped portion 11. Accordingly, the cutting apparatus (measuring apparatus) 2 further includes a measuring unit that measures the height of the upper surface 13 of the stepped portion 11 of the measurement target object 1 held by the holding table 18. Further, the measuring unit measures the height of the upper surface 13 of the stepped portion 11 at a plurality of measurement positions of the stepped portion 11. In the following, the cutting apparatus (measuring apparatus) 2 will further be described with a focus on a configuration that contributes to measurement of the height of the upper surface 13 of the stepped portion 11.

FIG. 5 schematically illustrates a measuring unit 70 that measures the height of the upper surface 13 of the stepped portion 11. The measuring unit 70 is, for example, preferably supported by the moving plate 36a or 36b that supports the cutting unit 24a or 24b and the camera unit 46a or 46b. Further, the measuring unit 70 is preferably able to be moved together with the cutting unit 24a or 24b and the camera unit 46a or 46b by the moving unit 22a or 22b being actuated. Moreover, when the holding table 18 is moved along the X-axis direction by the above-described X-axis moving mechanism being actuated, the relative position of the holding table 18 and the measuring unit 70 changes. In addition, when the rotational driving source that rotates the holding table 18 is actuated, a measurement region of the measuring unit 70 in the measurement target object 1 held by the holding table 18 is moved. That is, the moving unit 22a or 22b, the X-axis moving mechanism, and the rotational driving source have a function as a moving mechanism that moves the holding table 18 (measurement target object 1) and the measuring unit 70 relative to each other.

The measuring unit 70 includes, for example, a noncontact-type height measuring instrument 72. A measuring instrument sold under a product name “NCG” from DISCO Corporation can be cited as a typical example of the noncontact-type height measuring instrument 72. This measuring instrument projects laser light having a wavelength of approximately 1 μm onto the measurement target object 1, receives an interference wave between reflected light reflected by an upper surface of the measurement target object 1 and reflected light reflected by a lower surface of the measurement target object 1, and thereby measures the thickness of the measurement target object 1. The thicknesses (thickness distribution) of different positions of the measurement target object 1 before the edge trimming are known. Therefore, a cutting depth of the edge trimming can be calculated by subtracting a thickness of the measurement target object 1 which is obtained by measurement from an original thickness of the measurement target object 1. Further, when the thickness of the measurement target object 1 at a measurement position set to the stepped portion 11 is measured, the height of the upper surface 13 of the stepped portion 11 can be calculated from the original thickness of the measurement target object 1 at the measurement position. The height of the upper surface 13 of the stepped portion 11 at the measurement position is calculated by the controller 64, for example.

Incidentally, the measuring unit 70 may be able to change the spot diameter of the laser light projected from the height measuring instrument 72 onto the upper surface 13 of the stepped portion 11, that is, change the size of the measurement region. In addition, the width of the measurement region on the stepped portion 11 to be measured by the measuring unit 70 in one time of measurement is preferably smaller than the width of the stepped portion 11. In a case where the width (length in the radial direction of the measurement target object 1) of the stepped portion 11 is approximately 3 to 5 mm, the width of the measurement region is preferably approximately 1 mm. If the width of the measurement region is larger than the width of the stepped portion 11, a region different from the upper surface 13 of the stepped portion 11 is included in the measurement region. Therefore, the measured value obtained does not properly reflect the state of the stepped portion 11. That is, highly accurate measurement of the height of the upper surface 13 by the measuring unit 70 becomes possible when the width of the measurement region (spot diameter) of the measuring unit 70 is smaller than the width of the stepped portion 11.

It is to be noted that the height measuring instrument 72 of the measuring unit 70 is not limited to one that projects the laser light onto the measurement target object 1. For example, the height measuring instrument 72 may be a back pressure sensor. The back pressure sensor has a jetting port that blows air to the measurement target object 1. The back pressure sensor jets air from the jetting port to the measurement target object 1, and detects a pressure change occurring when the air is reflected by the measurement target object 1. This pressure change reflects a distance between the jetting port and a region to which the air is jetted (measurement region). The height of the measurement region can therefore be calculated on the basis of the pressure change.

A configuration of the back pressure sensor that can be used in the measuring unit 70 will be described in more detail. In the back pressure sensor, a jetting nozzle is coupled to an air supply source via a first path. Meanwhile, a second path is also connected to the air supply source. The second path communicates with the atmosphere. Gas is supplied from the air supply source to the first path and the second path at equal ratios. A differential pressure sensor is coupled between the first path and the second path. This differential pressure sensor includes a diaphragm that is displaced according to a difference between the pressure of the first path and the pressure of the second path. The differential pressure sensor outputs an electric signal (voltage value) corresponding to an amount of displacement of the diaphragm.

The jetting port at a distal end of the jetting nozzle is oriented in a direction of facing the measurement target object 1. When the measuring unit 70 is lowered, the jetting port of the jetting nozzle approaches the measurement target object 1. When there is no obstacle in the jetting direction of the air from the jetting port of the jetting nozzle, the first path is opened to the atmosphere in a manner similar to that of the second path. Therefore, the pressure of the first path and the pressure of the second path are equal to each other, the diaphragm of the differential pressure sensor is in a state of equilibrium, and a predetermined electric signal (voltage value) is output from the differential pressure sensor. In contrast, in a state in which the jetting port of the jetting nozzle has approached the measurement target object 1, the air jetted from the jetting port is reflected by the measurement target object 1, and the pressure of the first path thereby changes. Therefore, the diaphragm ceases to be in the state of equilibrium, and an electric signal (voltage value) corresponding to a distance between the jetting port and the measurement target object 1 is output from the differential pressure sensor.

When a relation between the electric signal (voltage value) output from the differential pressure sensor and the distance from the jetting port of the jetting nozzle to the measurement target object 1 is obtained in advance, the distance between the jetting port and the measurement region of the measurement target object 1 can be obtained on the basis of the electric signal (voltage value) output from the differential pressure sensor and the relation. This relation is preferably registered in advance in the storage device (storage unit) of the controller (control unit) 64, for example. The controller 64 calculates the height of the upper surface 13 of the stepped portion 11 from the electric signal (voltage value) output from the differential pressure sensor and the relation.

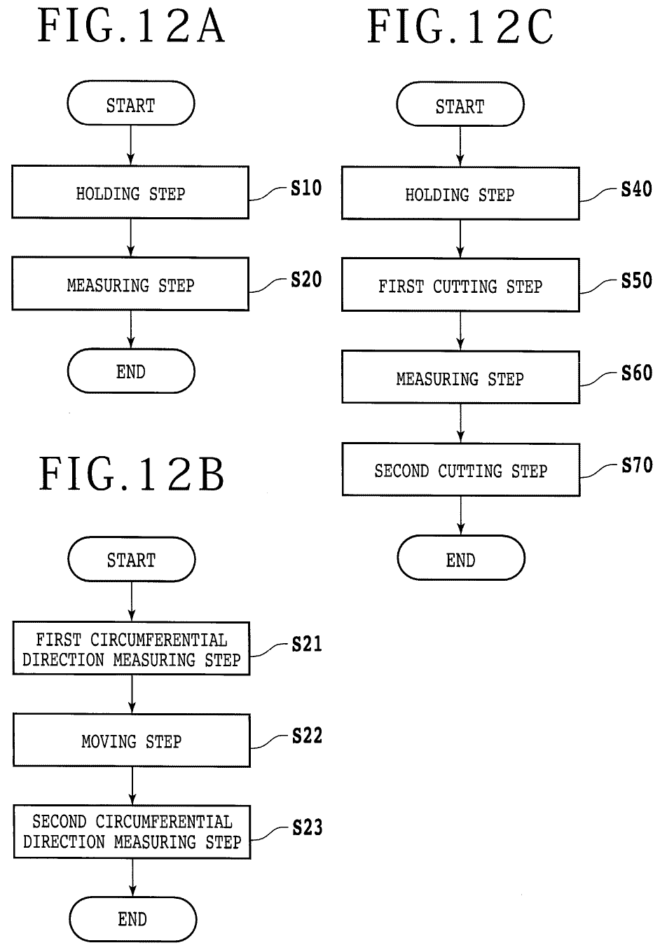

Description will next be made of a procedure of forming the stepped portion 11 in the measurement target object 1 by performing edge trimming and measuring the height of the upper surface 13 of the stepped portion 11 in the cutting apparatus (measuring apparatus) 2. The following description is a description of a processing method using the measurement target object 1 as a workpiece. Moreover, the processing method includes a measuring method for measuring the height of the upper surface 13 of the stepped portion 11 provided at the outer circumference 1c on the top surface 1a side of the measurement target object 1. FIG. 12C is a flowchart illustrating a flow of steps of the workpiece processing method according to the present embodiment.

The workpiece processing method illustrated in FIG. 12C performs a holding step S40 of holding the undersurface 1b side of the workpiece (measurement target object 1) by the holding table 18 such that the top surface 1a side of the workpiece (measurement target object 1) is exposed upward. In the holding step S40, first, the cassette 10 housing the frame unit in which the measurement target object 1, the tape, and the annular frame are integrated is transported to the cassette support base 8. Then, the measurement target object 1 (frame unit) is drawn out from the cassette 10 and placed onto the holding surface 18a of the holding table 18, and the measurement target object 1 is held under suction by the holding table 18 via the tape. FIG. 3 is a sectional view schematically illustrating the measurement target object 1 held by the holding table 18. Incidentally, in each figure, the tape and the annular frame included in the frame unit are omitted. When the measurement target object 1 is held under suction by the holding table 18, the top surface 1a side of the measurement target object 1 is exposed upward.

Next, a first cutting step S50 is performed. In the first cutting step S50, the outer circumference 1c of the workpiece (measurement target object 1) held by the holding table 18 is cut with use of the first cutting blade 56a fitted to the distal end of the rotatable spindle 50a. A stepped portion 11 is thereby formed in the workpiece (measurement target object 1). That is, the edge trimming of the measurement target object 1 is performed. FIG. 4 is a sectional view schematically illustrating the measurement target object 1 being cut by the first cutting blade 56a.

The first cutting unit 24a, for example, is used for the first cutting step S50. First, the position of the outer circumference 1c of the measurement target object 1 is detected by imaging the measurement target object 1 by the camera unit 46a. Then, the positions of the first cutting unit 24a and the holding table 18 are adjusted in such a manner as to position the cutting edge 60a of the first cutting blade 56a above the outer circumference 1c of the measurement target object 1. Next, rotation of the first cutting blade 56a is started by starting rotation of the spindle 50a, and the cutting edge 60a is made to cut into the measurement target object 1 by the first cutting unit 24a being lowered until a lowermost end of the cutting edge 60a reaches a depth exceeding the finished thickness as a depth from the top surface 1a of the measurement target object 1. In a case where the thickness of the measurement target object 1 is 700 μm, for example, a lower end of the first cutting blade 56a is preferably made to reach a position approximately 300 μm below the top surface 1a of the measurement target object 1. In a state in which the first cutting blade 56a is made to cut into the chamfered portion, the holding table 18 is rotated by 360° or more about the table rotational axis perpendicular to the holding surface 18a. Then, the measurement target object 1 is cut along the outer circumference 1c to partially cut off the chamfered portion, so that an annular stepped portion 11 (see FIG. 5 and the like) is formed in the measurement target object 1.

Subsequently, a measuring step S60 is performed after the first cutting step S50. In the measuring step S60, the height of the upper surface 13 of the stepped portion 11 is measured by the measuring unit 70, which measures the height of the upper surface 13 of the stepped portion 11 of the workpiece (measurement target object 1). FIG. 5 is a sectional view schematically illustrating the measurement target object 1 in the measuring step S60. The measuring step S60 is, for example, performed on the holding table 18 following the first cutting step S50. In a case where the measuring unit 70 includes the height measuring instrument 72 that measures the thickness of the measurement target object 1 by irradiating the measurement target object 1 with laser light 74, for example, a plurality of measurement regions is successively irradiated with the laser light 74 while the height measuring instrument 72 and the workpiece (measurement target object 1) are moved relative to each other. In particular, in the measuring step S60, the height of the upper surface 13 of the stepped portion 11 is measured at a plurality of measurement positions having different distances from the outer circumference 1c of the workpiece (measurement target object 1).

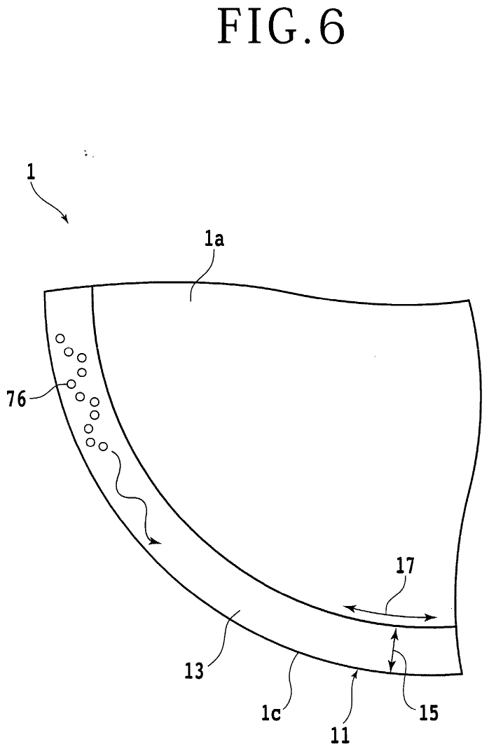

FIG. 6 is a plan view schematically illustrating an example of a movement trajectory of a measurement region 76 in the measuring step S60. For example, the measuring step S60 performs measurement while oscillating the measurement region along a radial direction 15 of the measurement target object 1 and moving the measurement region in a circumferential direction 17 in the stepped portion 11. FIG. 6 illustrates a part of the top surface 1a side of the measurement target object 1 in which the stepped portion 11 is formed. That is, the holding table 18 and the measuring unit 70 are moved relative to each other in such a manner as to move along the outer circumference 1c of the measurement target object 1 while the holding table 18 and the measuring unit 70 are oscillated relative to each other in a direction from the center of the measurement target object 1 to the outer circumference 1c and in a direction from the outer circumference 1c to the center. Then, the height of the upper surface 13 of the stepped portion 11 is measured at a plurality of measurement positions (positions of the measurement region 76). Incidentally, the movement of the measurement region 76 may be temporarily stopped while measurement is performed.

More specifically, the holding table 18 is rotated about the rotational axis perpendicular to the holding surface 18a while the moving unit 22a or 22b (see FIG. 2) oscillates the measuring unit 70 along the Y-axis direction. Then, in the stepped portion 11 of the measurement target object 1, the measurement region 76 moves as illustrated in FIG. 6. In this case, the position of the measurement region 76 (measurement position) on the upper surface 13 of the stepped portion 11 of the measurement target object 1 can be identified by the position in the Y-axis direction of the measuring unit 70 and the rotational angle of the holding table 18. A distribution of heights at different positions of the upper surface 13 of the stepped portion 11 is therefore obtained when the height of the upper surface 13 of the stepped portion 11 obtained by the measuring unit 70 and the position of the measurement region 76 at times of measurement are associated with each other and accumulated.

In the method of processing the workpiece (measurement target object 1) according to the present embodiment, the width of the measurement region 76 on the stepped portion 11 to be measured by the measuring unit 70 in one time of measurement is smaller than the width of the stepped portion 11 in the radial direction of the measurement target object 1. The measurement region 76 can therefore be moved as described above while control is performed such that the measurement region 76 does not go off the upper surface 13 of the stepped portion 11. Further, a height distribution of different positions of the upper surface 13 is derived with high accuracy because information regarding a region outside the upper surface 13 of the stepped portion 11 is not reflected in measured values.

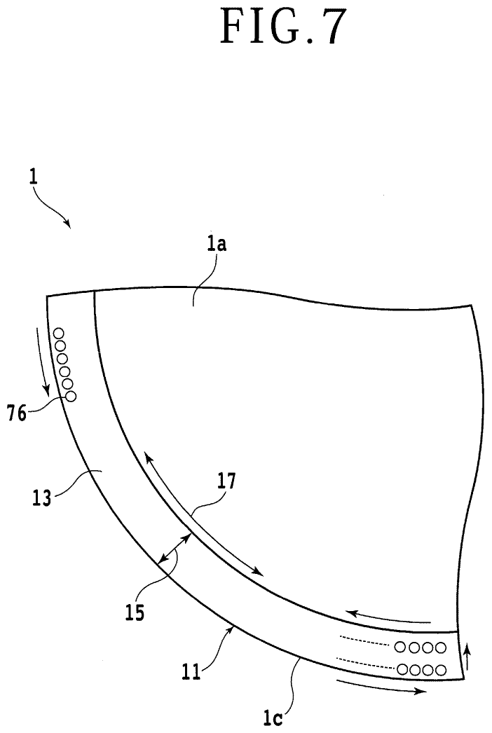

Incidentally, the movement mode of the measurement region 76 in the measuring step S60 is not limited to the mode illustrated in FIG. 6. FIG. 7 is a plan view schematically illustrating another example of the movement trajectory of the measurement region 76 in the measuring step S60. For example, in the measuring step S60, a height measurement is performed while the measurement position (position of the measurement region 76) is moved in the stepped portion 11 in such a manner as to move along the outer circumference 1c of the workpiece (measurement target object 1). Next, the measurement position is moved in the radial direction of the measurement target object 1. Further, height measurement is performed while the measurement position is moved in such a manner as to move along the outer circumference 1c of the measurement target object 1.

In the example illustrated in FIG. 7 in particular, the height of the upper surface 13 of the stepped portion 11 is measured at a measurement position relatively distant from the center of the measurement target object 1, and the measurement is repeated while the holding table 18 is rotated about the rotational axis perpendicular to the holding surface 18a. Consequently, the height of the upper surface 13 of the stepped portion 11 is measured at a plurality of measurement regions 76 separated from the center of the measurement target object 1 by a predetermined distance. Next, the measurement region 76 is brought closer to the center of the measurement target object 1, and the measurement is repeated while the holding table 18 is rotated about the rotational axis perpendicular to the holding surface 18a. The height of the upper surface 13 of the stepped portion 11 is thereby measured at a plurality of measurement regions 76 separated from the center of the measurement target object 1 by another predetermined distance. In this manner, the height of the upper surface 13 is measured at different positions of the stepped portion 11 while the movement of the measurement region 76 along the circumferential direction 17 and the movement of the measurement region 76 along the radial direction 15 are alternately repeated on the upper surface 13 of the stepped portion 11. As a result, a height distribution of different positions of the upper surface 13 is derived with high accuracy.

The height measurement of the upper surface 13 of the stepped portion 11 in the example illustrated in FIG. 7 will be described from another viewpoint. Each step illustrated in a flowchart of FIG. 12B is performed in the measuring step S60 in the example illustrated in FIG. 7. That is, a first circumferential direction measuring step S21, a moving step S22, and a second circumferential direction measuring step S23 are performed.

In the first circumferential direction measuring step S21, the height of the upper surface 13 of the stepped portion 11 is measured at a plurality of measurement positions while the holding table 18 and the measuring unit 70 are moved relative to each other in such a manner as to move along the outer circumference 1c of the measurement target object 1 (along the circumferential direction 17 of the measurement target object 1). Incidentally, the relative movement of the holding table 18 and the measuring unit 70 along the outer circumference 1c of the measurement target object 1 includes rotation of one of or both the holding table 18 and the measuring unit 70, that is, a change in direction thereof, and includes movement of one of or both the holding table 18 and the measuring unit 70 from the position thereof at that time. Further, rotation of one of or both the holding table 18 and the measuring unit 70 at the position thereof is also included. Typically, rotation of the holding table 18 about the rotational axis perpendicular to the holding surface 18a is indicated. However, there is no limitation to this.

Further, in the moving step S22 performed after the first circumferential direction measuring step S21, the holding table 18 and the measuring unit 70 are moved relative to each other in a direction from the center of the measurement target object 1 to the outer circumference 1c or in a direction from the outer circumference 1c to the center. That is, they are moved relative to each other along the radial direction 15. In the second circumferential direction measuring step S23 after the moving step S22, the height of the upper surface 13 of the stepped portion 11 is measured at a plurality of measurement positions while the holding table 18 and the measuring unit 70 are moved relative to each other in such a manner as to move along the outer circumference 1c of the measurement target object 1 (along the circumferential direction 17 of the measurement target object 1). Incidentally, after the second circumferential direction measuring step S23, a moving step and a circumferential direction measuring step may further be repeated alternately.

Incidentally, the position of the measurement region 76 (measurement position) in the measuring step S60 may be moved in still another mode. In any case, the method of processing the workpiece (measurement target object 1) according to the present embodiment measures the height of the upper surface 13 of the stepped portion 11 at a plurality of measurement positions having different distances from the outer circumference 1c of the workpiece in the measuring step S60. A height distribution in the width direction of the upper surface 13 of the stepped portion 11 is therefore obtained in detail.

When the stepped portion 11 is formed by cutting the workpiece (measurement target object 1) along the outer circumference 1c in the first cutting step S50, height variations along the width direction reflecting the state of the cutting edge 60a of the first cutting blade 56a occur in the upper surface 13 of the stepped portion 11. When the measuring step S60 is then performed, information regarding the height variations in the upper surface 13 of the stepped portion 11 is obtained, and the state of the cutting edge 60a is also identified from this information. When the state of the cutting edge 60a is found to be unsuitable for subsequent edge trimming, the first cutting blade 56a is preferably replaced. This enables high-quality edge trimming to be performed in the cutting apparatus 2.

In addition, the quality of the upper surface 13 of the stepped portion 11 may be improved by subsequently performing finish processing according to the state of the height variations in the upper surface 13 of the stepped portion 11. That is, in the method of processing the workpiece (measurement target object 1) according to the present embodiment, a second cutting step S70 may be performed after the measuring step S60. In other words, the method of processing the workpiece (measurement target object 1) according to the present embodiment may further include the second cutting step S70 performed after the measuring step S60.

FIG. 8 is a sectional view schematically illustrating the workpiece (measurement target object 1) in the second cutting step S70. The second cutting unit 24b is preferably used in the second cutting step S70. The diameter of the abrasive grains included in the cutting edge 60b of the second cutting blade 56b is smaller than the diameter of the abrasive grains included in the cutting edge 60a of the first cutting blade 56a. The second cutting blade 56b can therefore finish the upper surface 13 of the stepped portion 11 with high quality. However, the first cutting unit 24a may be used in the second cutting step S70.

In the second cutting step S70 performed after the measuring step S60, the stepped portion 11 of the workpiece (measurement target object 1) is further cut by the second cutting blade 56b including the abrasive grains whose diameter is smaller than the diameter of the abrasive grains included in the first cutting blade 56a. Moreover, in the second cutting step S70, such conditions as an amount of cutting of the second cutting blade 56b into the stepped portion 11 are preferably determined on the basis of information regarding the height of the upper surface 13 of the stepped portion 11 which information is obtained in the measuring step S60. For example, in the second cutting step S70, the amount of cutting of the second cutting blade 56b is determined to be an amount necessary and sufficient for finishing the upper surface 13 of the stepped portion 11 with high quality. The upper surface 13 of the stepped portion 11 can therefore be finished swiftly.

Incidentally, in a case where the first cutting blade 56a of the first cutting unit 24a is used in the second cutting step S70, the first cutting step S50 and the second cutting step S70 do not need to perform cutting under the same conditions. In the second cutting step S70, such conditions as the rotational speed of the cutting blade 56a and the rotational speed of the holding table 18 are preferably changed to settings different from those of the first cutting step S50 to perform edge trimming. The amount of cutting of the first cutting blade 56a into the stepped portion 11, in particular, is preferably determined on the basis of the information regarding the height of the upper surface 13 of the stepped portion 11.

The description thus far has been made of the procedure of forming the stepped portion 11 in the measurement target object 1 by performing edge trimming and measuring the height of the upper surface 13 of the stepped portion 11 in the cutting apparatus (measuring apparatus) 2. That is, the description has been made of the processing method using the measurement target object 1 as a workpiece. However, the cutting apparatus (measuring apparatus) 2 does not need to perform the edge trimming. For example, for a measurement target object 1 having been subjected to the edge trimming on the outside, the cutting apparatus (measuring apparatus) 2 may measure the height of the upper surface 13 of the stepped portion 11. In addition, the height of the upper surface 13 of the stepped portion 11 of the measurement target object 1 having been subjected to the edge trimming in the cutting apparatus 2 including the cutting units 24a and 24b may not be measured in the cutting apparatus 2, and may be measured in a measuring apparatus not including the cutting units 24a and 24b.

Description will next be made of a measuring method of measuring the height of the upper surface 13 of the stepped portion 11 provided to the outer circumference 1c on the top surface 1a side of the measurement target object 1. This measuring method performs some of a plurality of steps described in the above-described workpiece processing method. Therefore, the above description can be referred to as appropriate for each step to be described in the following. FIG. 12A is a flowchart illustrating a flow of the steps of the method of measuring the measurement target object.

First, a holding step S10 which holds the undersurface 1b side of the measurement target object 1 by the holding table 18 such that the stepped portion 11 is exposed upward is performed. This holding step S10 is performed in a manner similar to that of the holding step S40 in the above-described workpiece processing method. The stepped portion 11 is formed in advance by making a rotating cutting blade cut the outer circumference 1c of the measurement target object 1. However, the stepped portion 11 may be formed by a processing unit other than the cutting blade. In the holding step S10, the measurement target object 1 having the stepped portion 11 formed therein by being subjected to edge trimming is placed onto the holding table 18. At this time, the undersurface 1b of the measurement target object 1 is faced toward the holding surface 18a of the holding table 18 such that the stepped portion 11 is exposed upward.

Next, a measuring step S20 is performed which measures the height of the upper surface 13 of the stepped portion 11 by the measuring unit 70 that measures the height of the upper surface 13 of the stepped portion 11 of the measurement target object 1 held on the holding table 18. FIG. 5 is a sectional view schematically illustrating the measurement target object 1 having the height of the upper surface 13 of the stepped portion 11 measured in the measuring step S20. This measuring step S20 is performed in a manner similar to that of the measuring step S60 in the above-described workpiece processing method. The measuring step S20 may measure the height at different positions of the upper surface 13 of the stepped portion 11 while moving the measurement region 76 on the upper surface 13 of the stepped portion 11 in a zigzag manner along the outer circumference 1c of the measurement target object 1. That is, the holding table 18 and the measuring unit 70 are moved relative to each other in such a manner as to move along the outer circumference 1c of the measurement target object 1 while the holding table 18 and the measuring unit 70 are oscillated relative to each other in a direction from the center of the measurement target object 1 to the outer circumference 1c and a direction from the outer circumference 1c to the center. Then, the height of the upper surface 13 of the stepped portion 11 is measured at a plurality of measurement positions.

Alternatively, as described with reference to FIG. 7 and FIG. 12B, the measuring step S20 may perform the first circumferential direction measuring step S21, then perform the moving step S22, and thereafter perform the second circumferential direction measuring step S23. That is, the height measurement of the upper surface 13 of the stepped portion 11 is repeated while the measurement region 76 is moved along the circumferential direction 17 of the measurement target object 1, the measurement region 76 is next moved along the radial direction 15 of the measurement target object 1, and the height measurement of the upper surface 13 of the stepped portion 11 is repeated again while the measurement region 76 is moved along the circumferential direction 17 of the measurement target object 1. More specifically, in the first circumferential direction measuring step S21, the height of the upper surface 13 of the stepped portion 11 is measured at a plurality of measurement positions while the holding table 18 and the measuring unit 70 are moved relative to each other in such a manner as to move along the outer circumference 1c of the measurement target object 1. In the moving step S22, the holding table 18 and the measuring unit 70 are moved relative to each other in a direction from the center of the measurement target object 1 to the outer circumference 1c or in a direction from the outer circumference 1c to the center. In the second circumferential direction measuring step S23, the height of the upper surface 13 of the stepped portion 11 is measured at a plurality of measurement positions while the holding table 18 and the measuring unit 70 are moved relative to each other in such a manner as to move along the outer circumference 1c of the measurement target object 1.

In the measuring method described thus far, the width of the measurement region 76 on the upper surface 13 of the stepped portion 11 to be measured by the measuring unit 70 in one time of measurement is made smaller than the width in the radial direction 15 of the stepped portion 11. Therefore, the measuring step S20 can measure the height of the upper surface 13 of the stepped portion 11 at a plurality of measurement positions (positions of the measurement region 76) having different distances from the outer circumference 1c of the measurement target object 1. Consequently, highly accurate information regarding a height distribution of the upper surface 13 of the stepped portion 11 is obtained. Moreover, in the measuring method described thus far, the height of the upper surface 13 of the stepped portion 11 of the measurement target object 1 having the stepped portion 11 formed therein in advance is measured, and therefore, the cutting units 24a and 24b and the like are not used. Hence, the measuring apparatus that measures the height of the upper surface 13 of the stepped portion 11 does not have to include the configuration of a part of the cutting apparatus 2.

Description will next be made of configurations to be included in the measuring apparatus that measures the height of the upper surface 13 of the stepped portion 11 provided to the outer circumference 1c on the top surface 1a side of the measurement target object 1. Each of the configurations illustrated in the following is a configuration included in the cutting apparatus 2 described with reference to FIG. 2 and the like, and has been described. Detailed description of each configuration of the measuring apparatus will therefore be omitted. The measuring apparatus includes at least a holding table 18, a measuring unit 70, and a moving unit. The holding table 18 has a holding surface 18a, and holds the undersurface 1b side of the measurement target object 1 placed on the holding surface 18a such that the stepped portion 11 is exposed upward. The measuring unit 70 measures the height of the upper surface 13 of the stepped portion 11 of the measurement target object 1 held on the holding table 18.

The moving unit moves the holding table 18 and the measuring unit 70 relative to each other. More specifically, the moving unit can move the holding table 18 and the measuring unit 70 relative to each other in the X-axis direction, the Y-axis direction, and the Z-axis direction that are perpendicular to each other, and the moving unit rotates the holding table 18 about an axis perpendicular to the holding surface 18a. Moreover, the width of the measurement region 76 on the upper surface 13 of the stepped portion 11 to be measured by the measuring unit 70 in one time of measurement is smaller than the width of the stepped portion 11 in the radial direction 15 of the measurement target object 1. In addition, the measuring apparatus moves the holding table 18 and the measuring unit 70 relative to each other by controlling the moving unit, and measures the height of the upper surface 13 of the stepped portion 11 at a plurality of measurement positions having different distances from the outer circumference 1c of the measurement target object 1 by the measuring unit 70.

Further, as described with reference to FIG. 6, the measuring apparatus may perform the measurement while moving the measurement region 76 on the upper surface 13 of the stepped portion 11. That is, by controlling the moving unit, the measuring apparatus oscillates the holding table 18 and the measuring unit 70 relative to each other in a direction from the center of the measurement target object 1 to the outer circumference 1c and a direction from the outer circumference 1c to the center, and moves the holding table 18 and the measuring unit 70 relative to each other such that the holding table 18 and the measuring unit 70 move along the outer circumference 1c of the measurement target object 1. Then, the height of the upper surface 13 of the stepped portion 11 is measured at a plurality of measurement positions.

Alternatively, as described with reference to FIG. 7, the measuring apparatus may perform the measurement while alternately repeating movement in the circumferential direction 17 of the measurement region 76 and movement in the radial direction 15 of the measurement region 76. Specifically, by controlling the moving unit, the measuring apparatus measures the height of the upper surface 13 of the stepped portion 11 by the measuring unit 70 while moving the holding table 18 and the measuring unit 70 such that the holding table 18 and the measuring unit 70 move along the outer circumference 1c of the measurement target object 1. Next, the moving unit is controlled to move the holding table 18 and the measuring unit 70 relative to each other in a direction from the center of the measurement target object 1 to the outer circumference 1c or in a direction from the outer circumference 1c to the center. Next, the height of the upper surface 13 of the stepped portion 11 is measured while the moving unit is controlled to move the holding table 18 and the measuring unit 70 such that the holding table 18 and the measuring unit 70 move along the outer circumference 1c of the measurement target object 1.

The measuring apparatus includes the configurations described above, and is thus able to measure the height of the upper surface 13 of the stepped portion 11 of the measurement target object 1. However, the measuring apparatus may include another configuration. When the measuring apparatus obtains information regarding a height distribution of the upper surface 13 of the stepped portion 11, the state of the cutting edge of the cutting blade that has formed the stepped portion 11 can be identified, and correction work for the cutting blade can be performed as necessary. In addition, when the information regarding the height distribution of the upper surface 13 of the stepped portion 11 is obtained, appropriate conditions can be selected by referring to the information at a time of performing a further treatment on the stepped portion 11.

It is to be noted that the present invention is not limited to the description of the foregoing embodiment, and can be variously modified and carried out. For example, while, in the foregoing embodiment, the description has been made by taking as an example a case where the measurement target object 1 having the stepped portion 11 formed therein and having the height of the upper surface 13 of the stepped portion 11 measured is a disk-shaped wafer, one aspect of the present invention is not limited to this.

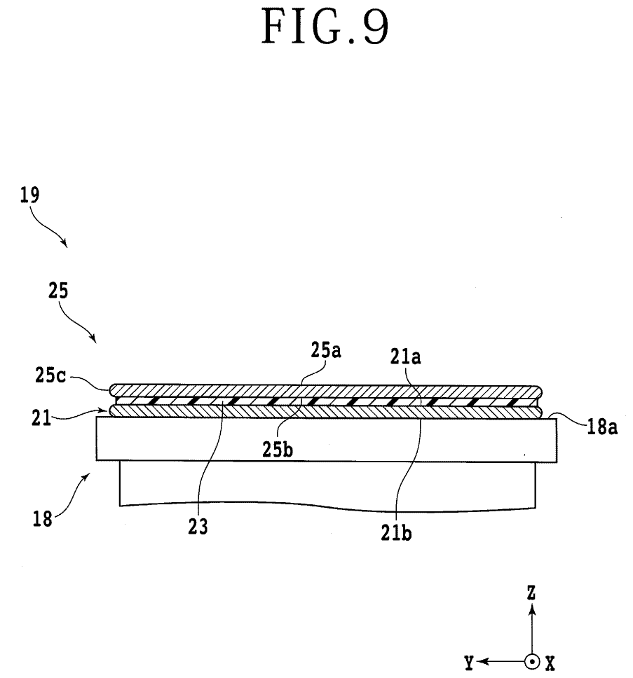

FIG. 9 is a sectional view schematically illustrating an example of a measurement target object placed on the holding table 18 and held under suction by the holding table 18. The measurement target object in the present example is an integral object 19 obtained by laminating one surface 25b of a disk-shaped wafer 25 and a surface (supporting surface) 21a of a supporting substrate 21 to each other by a laminating member 23. The supporting substrate 21 of the integral object 19 has a function of supporting the wafer 25 to be processed. The supporting substrate 21 includes silicon, for example, as a base material, and has a relatively high stiffness. The supporting substrate 21 is formed in a disk shape that is substantially the same shape as the wafer 25. Incidentally, the base material of the supporting substrate 21 may be sapphire, glass, or the like. In addition, in the integral object 19, the center of the supporting substrate 21 and the center of the wafer 25 substantially coincide with each other.

In the integral object 19, the one surface 25b of the wafer 25 and the surface (supporting surface) 21a of the supporting substrate 21 are laminated to each other as laminating surfaces via the laminating member 23. Thus, another surface 25a of the wafer 25 and an undersurface 21b of the supporting substrate 21 are exposed surfaces of the integral object 19. The laminating member 23 is, for example, an adhesive made of an ultraviolet curing resin.

A plurality of devices such as ICs or LSI circuits is formed in such a manner as to be juxtaposed to one another on the above-described one surface 25b as a laminating surface of the wafer 25. Further, when the wafer 25 is thinned by being ground from the other surface 25a side and is then divided for each device, individual device chips can be manufactured. Incidentally, devices may be formed also on the surface 21a side of the supporting substrate 21, and the devices formed on the supporting substrate 21 and the devices formed on the wafer 25 may be electrically connected to each other by connection paths such as conductor wires penetrating the laminating member 23.

A chamfered portion is formed at an outer circumference 25c of the wafer 25. The wafer 25 is subjected to edge trimming processing in a state in which the wafer 25 is supported by the supporting substrate 21. In a case where the surface 25b of the wafer 25 on which surface the devices are formed faces the supporting substrate 21, the wafer 25 is desired to be removed from the surface 25a to the surface 25b at the outer circumference 25c such that the chamfered portion does not remain at the outer circumference 25c of the wafer 25 that is thinned. However, when a cutting depth is larger than expected at a time of making a cutting blade cut the outer circumference 25c of the wafer 25, the cutting blade cuts into the laminating member 23 and the supporting substrate 21. Accordingly, a stepped portion 11 along the outer circumference 25c is formed in the wafer 25 without the cutting blade cutting to the surface 25b at the outer circumference 25c of the wafer 25. The stepped portion 11 that remains thereafter may be removed precisely.

Here, in order to precisely remove the stepped portion 11 formed in the wafer 25, a residual thickness of the wafer 25 at the stepped portion 11 needs to be identified. The height of the upper surface 13 of the stepped portion 11 is therefore desired to be measured. In particular, information regarding a height distribution in the width direction (radial direction) of the stepped portion 11 is desired. When this information is referred to, work of removing the stepped portion 11 can be performed under appropriately selected conditions.

In the following, description will be made of a workpiece processing method that forms the stepped portion 11 in the wafer 25 with the integral object 19 as a workpiece and measures the height of the upper surface 13 of the stepped portion 11. The following description includes a description of a measuring method that uses, as a measurement target object, the integral object 19 having the stepped portion 11 formed therein and measures the height of the upper surface 13 of the stepped portion 11 of the measurement target object.

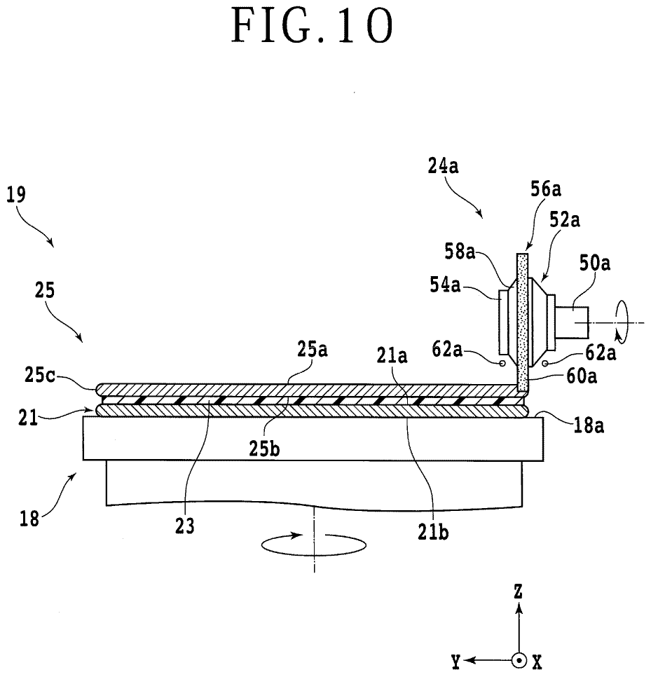

In this workpiece processing method, first, the undersurface side of the integral object 19 (undersurface 21b side of the supporting substrate 21) is held by the holding table 18 such that the top surface side of the integral object 19 (workpiece/measurement target object) (surface 25a side of the wafer 25) is exposed upward (holding step). FIG. 9 is a sectional view schematically illustrating the integral object 19 held under suction by the holding table 18 of the cutting apparatus 2. Next, a stepped portion 11 is formed in the integral object 19 by cutting an outer circumference of the integral object 19 (workpiece/measurement target object) (the outer circumference 25c of the wafer 25) held by the holding table 18, with use of the first cutting blade 56a fitted to the distal end of the rotatable spindle 50a (cutting step). FIG. 10 is a sectional view schematically illustrating a state in which the outer circumference 25c of the wafer 25 of the integral object 19 is cut by the first cutting blade 56a. The stepped portion 11 is thereby formed on the other surface 25a side of the wafer 25 which surface 25a side corresponds to the top surface side of the workpiece/measurement target object.

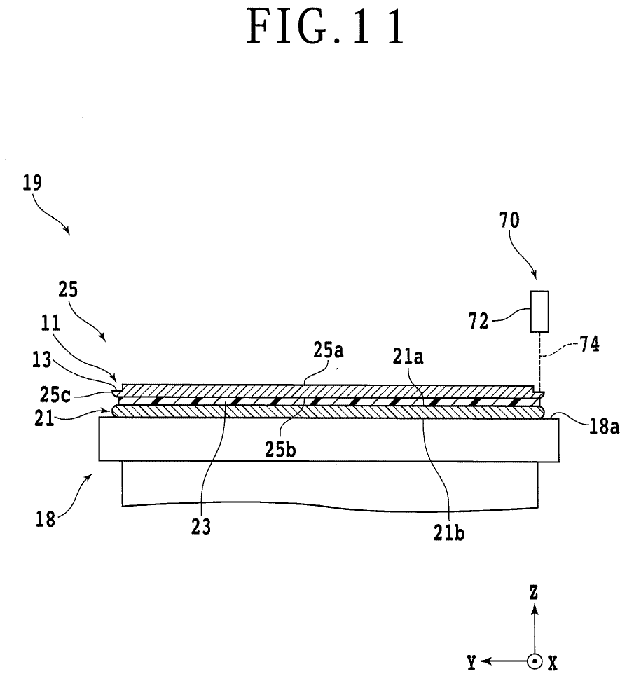

Thereafter, the height of the upper surface 13 of the stepped portion 11 of the integral object 19 (workpiece/measurement target object) is measured by the measuring unit 70 (measuring step). That is, the height of the upper surface 13 of the stepped portion 11 formed on the other surface 25a side of the wafer 25 is measured, the other surface 25a side corresponding to the top surface side of the workpiece/measurement target object. FIG. 11 is a sectional view schematically illustrating a state in which the height of the upper surface 13 of the stepped portion 11 formed at the outer circumference 25c of the wafer 25 of the integral object 19 is measured by the measuring unit 70.

Also in this workpiece processing method, the width of the measurement region 76 on the upper surface 13 of the stepped portion 11 to be measured by the measuring unit 70 in one time of measurement is smaller than the width of the stepped portion 11. Therefore, at a time of measuring the height of the upper surface 13 of the stepped portion 11, the height of the upper surface 13 of the stepped portion 11 can be measured at a plurality of measurement positions having different distances from the outer circumference 25c of the wafer 25 of the integral object 19 (outer circumference of the workpiece/measurement target object). It is thereby possible to obtain a height distribution of different positions of the upper surface 13 of the stepped portion 11 as information regarding the height of the upper surface 13 of the stepped portion 11.

After the height distribution of the different positions of the upper surface 13 of the stepped portion 11 formed in the wafer 25 of the integral object 19 is obtained, the stepped portion 11 may be removed by performing further cutting (edge trimming) by a cutting blade under conditions selected on the basis of the obtained information, for example. In addition, the stepped portion 11 may be removed by another method. For example, the stepped portion 11 may be removed by etching processing using a chemical solution. Also in this case, when the height distribution of the different positions of the upper surface 13 of the stepped portion 11 is obtained, the thickness of the wafer 25 at the different positions of the stepped portion 11 can be identified, and conditions for the etching processing (a processing time, a chemical solution concentration, and the like) can be determined appropriately.

In addition, in the foregoing embodiment, description has been made of a case where the height is measured at different positions of the upper surface 13 of the stepped portion 11 formed mainly in a disk-shaped wafer. However, the measurement target object/workpiece is not limited to the disk-shaped wafer. For example, the measurement target object/workpiece may be a substrate in a rectangular shape. According to one aspect of the present invention, it is possible to obtain information regarding a height distribution of different positions by measuring the height of an upper surface of a stepped portion formed along an outer circumference of the substrate in a rectangular shape.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A measuring method for measuring a height of an upper surface of a stepped portion provided to an outer circumference on a top surface side of a measurement target object, the measuring method comprising:
a holding step of holding an undersurface side of the measurement target object by a holding table such that the stepped portion is exposed upward; and
a measuring step of measuring the height of the upper surface of the stepped portion by a measuring unit configured to measure the height of the upper surface of the stepped portion of the measurement target object held by the holding table, wherein
a width of a measurement region on the upper surface of the stepped portion to be measured by the measuring unit in one time of measurement is smaller than a width of the stepped portion, and,
in the measuring step, the height of the upper surface of the stepped portion is measured at a plurality of measurement positions having different distances from the outer circumference of the measurement target object.

2. The measuring method according to claim 1, wherein
in the measuring step, the holding table and the measuring unit are moved relative to each other such that the holding table and the measuring unit are moved along the outer circumference of the measurement target object while oscillating the holding table and the measuring unit relative to each other in a direction from a center of the measurement target object to the outer circumference and in a direction from the outer circumference to the center, and the height of the upper surface of the stepped portion is measured at the plurality of measurement positions.

3. The measuring method according to claim 1, wherein
the measuring step includes
a first circumferential direction measuring step of measuring the height of the upper surface of the stepped portion at the plurality of measurement positions while moving the holding table and the measuring unit relative to each other such that the holding table and the measuring unit are moved along the outer circumference of the measurement target object,
a moving step of, after the first circumferential direction measuring step, moving the holding table and the measuring unit relative to each other in a direction from a center of the measurement target object to the outer circumference or in a direction from the outer circumference to the center, and
a second circumferential direction measuring step of, after the moving step, measuring the height of the upper surface of the stepped portion at the plurality of measurement positions while moving the holding table and the measuring unit relative to each other such that the holding table and the measuring unit are moved along the outer circumference of the measurement target object.

4. The measuring method according to claim 1, wherein
the measurement target object is an integral object obtained by laminating one surface of a disk-shaped wafer and a supporting surface of a supporting substrate to each other by a laminating member, and
in the measuring step, the height of the upper surface of the stepped portion formed on another surface side of the wafer, which is the top surface side of the measurement target object, is measured.

5. The measuring method according to claim 1, wherein
the stepped portion is formed by making a rotating cutting blade cut the outer circumference of the measurement target object.

6. A processing method for processing a workpiece, the processing method comprising:
a holding step of holding an undersurface side of the workpiece by a holding table such that a top surface side of the workpiece is exposed upward;
a first cutting step of forming a stepped portion in the workpiece by cutting an outer circumference of the workpiece held by the holding table, with use of a first cutting blade fitted to a distal end of a rotatable spindle; and
a measuring step of, after the first cutting step, measuring a height of an upper surface of the stepped portion by a measuring unit configured to measure the height of the upper surface of the stepped portion of the workpiece, wherein
a width of a measurement region on the upper surface of the stepped portion to be measured by the measuring unit in one time of measurement is smaller than a width of the stepped portion, and,
in the measuring step, information regarding the height of the upper surface of the stepped portion is obtained by measuring the height of the upper surface of the stepped portion at a plurality of measurement positions having different distances from the outer circumference of the workpiece.

7. The processing method according to claim 6, further comprising:
a second cutting step of, after the measuring step, further cutting the stepped portion of the workpiece by the first cutting blade or a second cutting blade including abrasive grains having a diameter smaller than a diameter of abrasive grains included in the first cutting blade, wherein
in the second cutting step, an amount of cutting of the first cutting blade or the second cutting blade is determined based on the information obtained in the measuring step.

8. A measuring apparatus for measuring a height of an upper surface of a stepped portion provided to an outer circumference on a top surface side of a measurement target object, the measuring apparatus comprising:
a holding table that has a holding surface and is configured to hold an undersurface side of the measurement target object placed on the holding surface such that the stepped portion is exposed upward;
a measuring unit configured to measure the height of the upper surface of the stepped portion of the measurement target object held by the holding table; and
a moving unit configured to move the holding table and the measuring unit relative to each other, wherein
a width of a measurement region on the upper surface of the stepped portion to be measured by the measuring unit in one time of measurement is smaller than a width of the stepped portion, and
the measuring apparatus is capable of measuring the height of the upper surface of the stepped portion by the measuring unit at a plurality of measurement positions having different distances from the outer circumference of the measurement target object while controlling the moving unit to move the holding table and the measuring unit relative to each other.

9. The measuring apparatus according to claim 8, wherein
the moving unit is controlled to oscillate the holding table and the measuring unit relative to each other in a direction from a center of the measurement target object to the outer circumference and in a direction from the outer circumference to the center and to move the holding table and the measuring unit relative to each other such that the holding table and the measuring unit move along the outer circumference of the measurement target object, and the height of the upper surface of the stepped portion is measured at the plurality of measurement positions.

10. The measuring apparatus according to claim 8, wherein
the height of the upper surface of the stepped portion is measured by the measuring unit while the moving unit is controlled to move the holding table and the measuring unit such that the holding table and the measuring unit move along the outer circumference of the measurement target object, the moving unit is controlled to next move the holding table and the measuring unit relative to each other in a direction from a center of the measurement target object to the outer circumference or in a direction from the outer circumference to the center, and then, the height of the upper surface of the stepped portion is measured while the moving unit is controlled to move the holding table and the measuring unit such that the holding table and the measuring unit move along the outer circumference of the measurement target object.

11. The measuring apparatus according to claim 8, wherein
the measurement target object is an integral object obtained by laminating one surface of a disk-shaped wafer and a supporting surface of a supporting substrate to each other by a laminating member, and
the height of the upper surface of the stepped portion formed on another surface side of the wafer, the other surface side corresponding to the top surface side of the measurement target object, is measured by the measuring unit.

12. The measuring apparatus according to claim 8, wherein
the stepped portion is formed by making a rotating cutting blade cut the outer circumference of the measurement target object.
